(19) United States
(12) Patent Application Publication
(10) Pub. No.: US 2005/0023917 A1
(43) Pub. Date: Feb. 3, 2005

(54) Electric motor and method for producing the motor

(75) Inventors: Gunter Kesting, Ilmenau (DE); Andreas Mockel, Leipzig (DE); Dieter Oesingmann, Ilmenau (DE); Ronald Schuder, Geschwenda (DE); Wilfried Wintzer, Ilmenau (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/873,384

(22) Filed: Jun. 21, 2004

Related U.S. Application Data
(63) Continuation of application No. PCT/EP02/13459, filed on Nov. 28, 2002.

(30) Foreign Application Priority Data
Dec. 21, 2001 (DE) 101 63 544.3

(51) Int. Cl. H02K 21/12

(52) U.S. Cl. 310/156.43

(57) ABSTRACT

An electric motor has improved electrical, magnetic, and mechanical properties, and especially favorable mass-power ratio, as well as an economical method for producing the novel motor. The electric motor is formed as a permanent-magnet excited electric motor that has a symmetrically built support with pole gap excitations. Low structural height h_{M} high energy magnets are provided for excitation purposes.

### CROSS-REFERENCE TO RELATED APPLICATION

This application is a continuation, under 35 U.S.C. § 120, of copending international application No. PCT/EP02/13459, filed Nov. 28, 2002, which designated the United States; this application also claims the priority, under 35 U.S.C. § 119, of German patent application No. 101 63 544.3, filed Dec. 21, 2001; the prior applications are herewith incorporated by reference in their entirety.

### BACKGROUND OF THE INVENTION

Field of the Invention

The present invention relates to an electric motor, and to a method for the production of an electric motor.

Commutator motors with electrical excitation and with permanent magnet excitation form the vast majority of motors in the power range from a few watts up to 3000 W. The rotational speed range of these motors is between 2000 rpm and 60,000 rpm. Fields of operation include, for example, low-voltage applications as auxiliary propulsion systems in vehicles, and in battery-powered appliances, as well as the wide range of mains-powered domestic appliances, for example vacuum cleaners, washing machines, coffee grinders, cookers, and the like, as well as handheld tools, such as drills and grinders.

A commutator motor comprises a stator to which the excitation system is fitted, and a rotor which is manufactured as an external rotor or internal rotor. Motors with permanent magnet excitation are largely used in the rotational speed range up to 10,000 rpm, and in some cases up to 20,000 rpm, while motors with electrical excitation have their main field of application in the upper rotational speed range.

In comparison to motors with electrical excitation, motors with permanent magnet excitation are distinguished by being physically considerably simpler and, associated with this, by lower manufacturing costs. Furthermore, the stator windings in motors with electrical excitation always result in losses which in principle cannot occur in motors with permanent magnet excitation, so that motors with permanent magnet excitation are more efficient.

Currently, most motors with permanent magnet excitation are manufactured with anisotropic ceramic magnets. In most cases, the motor cross section is circular. The cross section differs from a circular shape only in a small number of two-pole motors, owing to the flats in the pole gaps. This form of motor is often referred to as a “flat motor.” The diameter and the length of motors such as these with permanent magnet excitation depend largely on the application, in which case only one of the two variables that have been mentioned can be specified for the design of the magnetic circuit. The rotor configuration is governed by the number of slots and commutator webs, and this number is chosen to be as small as possible, in order to limit the manufacturing costs.

Motor design is governed primarily by the magnetic relationships and characteristics, as well as material/economical considerations derived from these relationships. When optimization attempts are made, it should be remembered that some of the dimensions are not optimization parameters. These include, inter alia:
minimum air gap length of δ≈0.5 mm;
minimum magnet height of about 1 mm to about 4.5 mm;
use of pole segments with a pole arc of a maximum of αₚ=145°.

Designing the magnets as pole segments which are positioned immediately adjacent to the air gap guarantees the lowest scatter factor. The component on which most weight can be saved is the stator yoke, which may at the same time represent the motor housing and the mounting plane. From the magnetic point of view, this results in excessively thin yokes, which are also desirable because the machining of thin metal sheets involves lower manufacturing costs. The disadvantage that the air gap flux is limited is accepted in this case.

In the extreme, the design of the stator yokes for motors with permanent magnet excitation is characterized by the efforts to allow the motors to be produced at as low a cost as possible. This is expressed by the manufacturing technologies for stator yokes, such as:
metal-cutting production;
cutting and bending methods;
rolling;
deep drawing or thermoforming.

These methods are based on the use of integral semi-finished products as the initial material, which are formed and shaped and remain integral as the stator yoke. Owing to the characteristic of the stator yokes, they at the same time carry out the functions of motor housings. These solutions are made possible not only because only constant fluxes and no eddy currents occur in the stator, so that no losses occur even in the solid iron, but because the rotor diameters are so small that yoke thicknesses of up to b_{JS}=3 mm are sufficient for the flux levels in the magnets used so far. These material thicknesses can be handled with by the metal machining methods listed above.

For trial samples or small batches, the stator yokes are produced from solid material. The metal-cutting machining methods that are used for this purpose are normally replaced by lower-cost non-cutting shaping processes for series production.

Cutting and bending methods are used for stator yokes which are required when using block magnets. These comprise two identical parts, each of which has one or two flat sections and a curved area.

Rolled yokes are used not only for circular stator contours, but also for flattened stator contours. These may have any desired length in the axial direction, and may have yoke thicknesses of up to 3 mm. Adaptations to different laminated core lengths can be carried out easily. Two end frames are required.

Drawn yokes, which form pot shapes, are an alternative to rolled yokes. These have considerable cost advantages for small rotor diameters for which only thin metal sheets are required, and for short laminated cores, because the shaping effort is then not as great. The pot shape makes it easier to comply with higher degrees of ingress protection, relating to the ingress of dirt and water, than other designs. However, a specific tool set must be provided for each motor length. The costs for this rise considerably with the pot length, so that the efforts involved must be calculated well. Deep-drawing or thermoforming methods can likewise be used for the construction of the yokes, in contrast to the round shape as housings for flat motors. The closed part of the pot is used to hold axial and radial bearings, thus saving one end frame as a separate component.

The design of motors with electrical excitation is wherein the ferromagnetically active parts of the stator and rotor are laminated cores which have low axial magnetic permeability, and are therefore designed to be the same length. The end windings occupy a large amount of space, with the magnetic characteristics of the stator yokes and of the laminated rotor core being ignored.

### SUMMARY OF THE INVENTION

It is accordingly an object of the invention to provide an electric motor and a production method which overcome the above-mentioned disadvantages of the heretofore-known devices and methods of this general type and which provides an electric motor with improved electrical, magnetic, design, and mechanical characteristics and, in particular, with improved mass/power ratio, and which provides an economic method for its production. It is a further aim to the field of use of motors with permanent magnet excitation.

With the foregoing and other objects in view there is provided, in accordance with the invention, an electric motor with permanent magnet excitation, the motor having a substantially symmetrical stator with pole gap excitation, and a high-energy magnet formed with a small magnet height.

In other words, the electric motor according to the invention is distinguished as an electric motor with permanent magnet excitation which has a symmetrical stator with pole gap excitation, it has low height high-energy magnets for excitation. In this case, the invention is primarily based on the following discoveries.

Thin stator yokes, to which the dimensions of the rotor are matched, often mean that the replacement of ceramic magnets in motors according to the prior art by high energy magnets without changing the fundamental design does not lead to any significant performance improvements. Higher magnet material costs for high energy magnets are thus not sufficiently compensated for by lower mass/power ratios. A symmetrical design with pole gap magnets furthermore slightly simplifies the manufacture of such motors, which have a very short geometric extent on the pole axis.

In one embodiment of the invention, rare earth magnets are provided as high energy magnets, in particular neodymium/iron/boron magnets. The replacement of ceramic magnets by neodymium/iron/boron magnets advantageously leads not only to a reduction in the magnet volume, but also to an increase in the air gap flux. The ratio of the magnet volume of a high energy magnet to that of ceramic magnets is thus approximately 1:20.

The intended shapes of high energy magnets, being rhombic or cuboid, are substantially easier to manufacture than pole half shells. Furthermore, a high energy magnet for a machine according to the invention is very thin in comparison to a ceramic magnet and, in particular, has a magnet height of only about 1 mm to about 4.5 mm.

In accordance with an added feature of the invention, a high energy magnet is arranged at an angle other than a right angle with respect to the air gap. Particularly in the case of magnets whose length corresponds approximately to the rotor radius, the motor width can be reduced by arranging it at an acute angle with respect to the air gap, rather than at right angles. The magnets can be rotated in the same way or in opposite directions in both pole gaps. This results in a number of possible ways to adapt a respective motor external shape in order to physically integrate a motor according to the invention in an appliance.

The positioning of rare earth magnets on both sides in order to form the air gap field in a two-pole machine according to the invention is thus associated, on the basis of one or more of the features mentioned above, with the following advantages, among others:
in comparison to asymmetric motors, the radial tension in one direction is cancelled out, with an improvement in the conditions for a bearing, while reducing the amount of noise developed;
shortening of the excitation lines of flux and thus a reduction in the magnetic potential drop in the stator yoke;
Reduction in the dimensions on the pole axis or of the axial length;
enlargement of the pole arc owing to the small magnet thickness and height, which can be reduced to a thickness of down to about h_{M}=1 mm;
Reduction in the pole sensing torques, because the holding torques can be more effectively reduced by smaller slot inclinations, in comparison to the prior art;
simple magnet shape in comparison to the pole segments of ceramic magnets;
Reduction in the brush yoke rotation owing to the smaller pole gap;
provision of stator yokes with any desired axial length, with an improvement in the flux concentration in the pole arc;
lengthening of the magnets in the radial and axial directions allows the flux to be increased and concentrated;
the design of flat motors in the case of motors such as these is not dependent on a reduction in the pole arc as in the case of present-day embodiments;
The smallest external dimension is located at the pole center.

If the axial extents of the stator and rotor are the same, then a jig saw tool can preferably be used for effective production of an electric motor such as this incorporating one or more of the features mentioned above, carrying out stamped packetization of the stator and armature laminated cores in order to form a symmetrical motor which is permanently excited by high energy magnets.

At least two parts of a stator are preferably connected to one another by adhesive bonding and/or sheathing with a housing, by means of at least two (or some other even number of) high energy magnets in order to form an integral stator.

An electric motor according to the invention also allows the use of machines with permanent magnet excitation based on high energy magnets over the entire rotational speed and power range mentioned above, based on a standard fundamental concept for a new large number of geometric parameters which can be adjusted relatively freely.

Other features which are considered as characteristic for the invention are set forth in the appended claims.

Although the invention is illustrated and described herein as embodied in a electric motor, and method for its production, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a sketch illustration of a prior art asymmetric electric motor with permanent magnet excitation and having an armature with five slots;

FIG. 2 is a schematic view of a cross section through an electric motor according to the invention;

FIG. 3 is a typical cross section through a two-pole motor with permanent magnet excitation;

FIG. 4 is a longitudinal section through the motor with permanent magnet excitation as shown in FIG. 3;

FIG. 5 is a diagrammatic graph illustrating the reduction in the air gap flux as a function of the overhang factor; and

FIGS. 6A to 6D are axial-view sketches illustrating various options for shaping the external contour of a stator according to the invention with pole gap magnets, in the form of a dimensioned embodiment.

### DESCRIPTION OF THE PREFERRED EMBODIMENTS

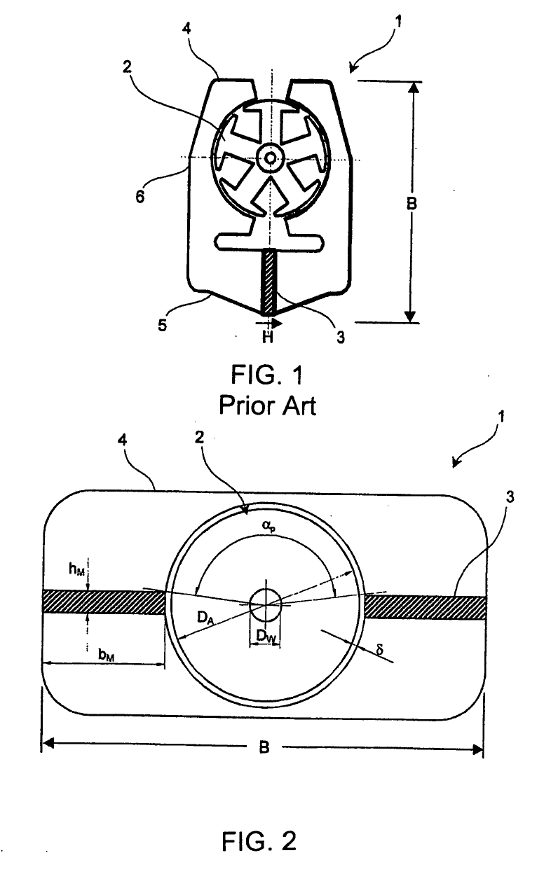

A range of developments of motors with pole gap excitation can be derived from the prior art, in which a horseshoe magnet was first of all replaced by an electrical field coil and, finally, the development of anisotropic ceramic magnets using block magnets. During this process, the manufacturing costs, losses and physical sizes were continuously decreased, with the failure rates also being considerably reduced in the final stage of the described development process, owing to the lack of wire links in the stator. The replacement of cut and bent parts by laminated cores, which can be stamped as packets and can be produced in a manner such that they are easy to assemble, resulted in considerable production advantages, with the replacement of ceramic magnets by high energy magnets based, for example, on neodymium/iron/boron leading not only to a reduction in the magnet volume, but also to an increase in the air gap flux. However, overall, simple replacement of ceramic magnets by high energy magnets in known electric motors without any fundamental design changes does not lead to any significant performance improvements, so that the higher magnet material costs cannot be compensated for adequately by the lower mass/power ratios. The use of high energy magnets is thus still restricted to a relatively small number of fields of use. The illustration in FIG. 1 shows a sketch of a prior art asymmetric electric motor 1 with permanent magnet excitation and with an armature 2 with five slots as an example of a stator 4 which is equipped with a high energy magnet 3 for a motor 1 that is used as a drive in a model train.

Too little attention, if any at all, is paid to the magnetic characteristics of the stator yokes and of the rotor laminated core in the design of virtually all motors with permanent magnet excitation. However, one fundamental discovery as a starting point for an electric motor according to the invention is that thin stator yokes, to which the dimensions of the rotor are also matched, in motors according to the prior art have often been the reason why the replacement of ceramic magnets by high energy magnets has not led to significant performance improvements in motors such as these. The use of motors equipped with high energy magnets is thus currently primarily restricted to applications in which only a very small amount of space is available, as in the case of a motor for a model train locomotive as shown in FIG. 1. The reduction in the space required for motors such as these is in this case solely due to a considerably lower volume/flux ratio from the high energy magnets, in comparison to ceramic permanent magnets.

The technologically simple horseshoe shape of the stator 4 with yoke and pole areas 5, 6 which can be distinguished in FIG. 1 can be replaced, without increasing the magnet weight or the motor width B, by a symmetrical configuration as illustrated in the form of a sketch in FIG. 2. In the case of motors of the illustrated type with pole gap magnets, the pole and yoke areas 5, 6 can virtually not be separated, so that the magnetically active part of the stator 4 comprises the poles or pole elements and the magnets 3. The methods used to manufacture stator poles are influenced by the application and by the motor dimensions. The number of configuration options is relatively large, and allows for the use of different materials and manufacturing methods.

FIG. 2 indicates various measurement characteristics. The magnet 3 has a very small thickness or magnet height h_{M}. In the illustrated embodiment, the height h_{M} is less than a shaft diameter D_{W}, substantially less than a magnet width b_{M} and than a motor armature D_{A}. The motor width B corresponds approximately to twice the width b_{M} and the diameter D_{A}.

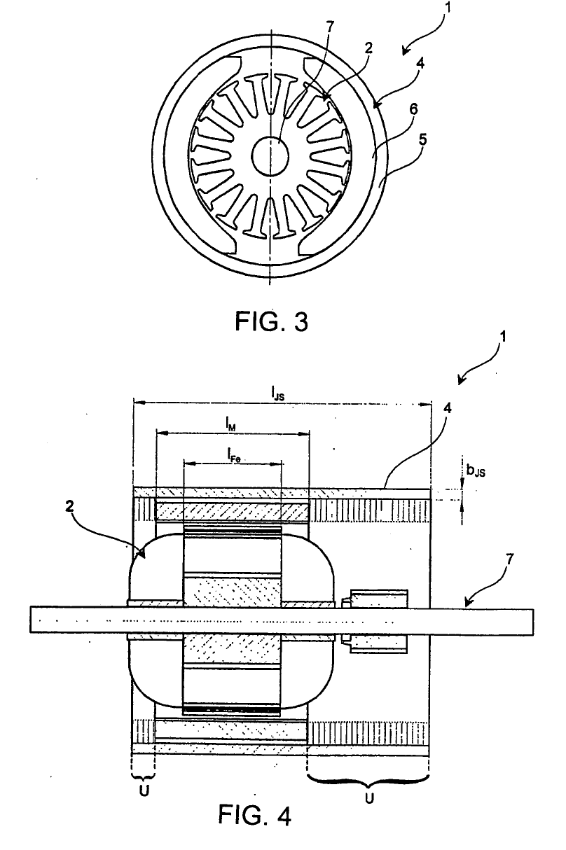

The typical cross section of a commutator motor with permanent magnet excitation is characterized by the slotted rotor, the magnet, which is located immediately adjacent to the air gap as a shell magnet, and the yoke as a circular magnetic return path, which at the same time forms the housing, as is illustrated in FIG. 3. This fundamental shape can also be used as the basis for the further analyses of exemplary embodiments of the invention.

The illustration in FIG. 4 shows a longitudinal section through the motor shown in FIG. 3. In this case, measures are disclosed for utilization of the rotor volume as well as possible, while at the same time showing the dimensions which limit the power. The laminated rotor core I_{Fe} has the smallest axial extent of the magnetically active parts. In order to make the flux through the rotor as large as possible, the permanent magnet is lengthened beyond the laminated core length, with the ratio of the magnet length I_{M} and of the laminated core length I_{Fe} in motors that have been designed being in the range

$$\frac{{I}_{M}}{{I}_{Fe}} \approx 1.2 \cdot / \cdot 1.8$$

The magnetic return path composed of solid steel, which physically represents the housing, allows the magnetic flux to be guided three-dimensionally. For this reason, the required cross section can be achieved by a great axial length I_{JS} and a small radial extent b_{JS}. This allows simple and highly productive manufacturing methods; however, their limit is reached at yoke thicknesses of about b_{JS}=3 mm.

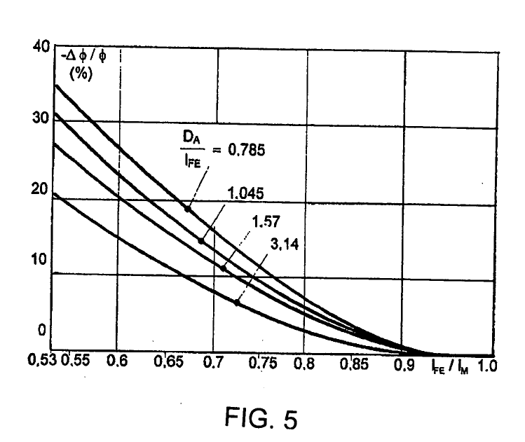

In order to reduce the flux density in the stator yoke, the axial length of the stator yoke is chosen to be greater than that of the permanent magnet. Particularly in the case of short motors, this measure has a positive effect on the magnetic potential drops in the stator. Simple attachment of the end frames to the stator yoke, in some cases without the use of bolts, is a design aspect for lengthening the stator yokes beyond the end windings and the brush holders. The magnetic flux is governed by the magnet quality and by the rotor surface. The edge fields which are produced as a result of the lengthening of the magnets beyond the laminated rotor core allow the flux through the brush level to be increased only to a limited extent, because the path of the lines of flux through the air becomes ever greater. Guideline values for this are shown in the experimentally determined diagram in FIG. 5. This shows the relative reduction in the air gap flux ΔΦ/Φ as a function of the overhang factor I_{Fe}/I_{M}. The ratio of the armature diameter DA to a respective armature or iron length I_{FE} is indicated as one parameter.

The stator return path is extended on one side to beyond the commutator area, while the yoke overhangs the core length only by the length of the end windings on the other side. The space in the axial lengthening of the magnets is unused on both sides, as is indicated in the illustration in FIG. 4 by the two brackets annotated U.

The magnetic flux, which is limited for several reasons by the design of the motor, means that a small rotor yoke cross section is sufficient, without having to enter the saturation area. A large winding area is thus available in the slots in the rotor, which cannot be completely used for thermal reasons or owing to the limit on the maximum permissible opposing fields, because of the risk of demagnetization of the pole segments.

The motor diameter of two-pole motors is limited by the low-cost stator yoke technologies that are currently used. The power is increased mainly by lengthening the axial extent of the entire motor. The magnetic flux can be increased to a limited extent by means of pole segments composed of high energy material without changing the fundamental design, but this is still impractical, owing to the costs. It should be remembered that the manufacturing costs of the pole segments rise more than proportionally with their size, and the maintenance of the correct dimensions during the production of such permanently magnetic ceramics becomes ever more problematic. In this case, embodiments with pole gap magnets, in particular in embodiments as shown in FIG. 2, represent an alternative to the known motors with pole magnets.

In embodiments of motors with pole gap magnets, the flux is also guided from the overhang regions through ferromagnetic sections of the pole elements as far as the air gap. This is done by means of experimental three-dimensional field calculations, in order to determine optimum overhang factors and pole element shapes. The axial length of the magnet can be chosen to be as long as the stator yoke. This allows optimum space utilization with comparatively small overhang factors and very small external dimensions.

The pole gap magnets are located in a magnetic circuit in which the path through air is twice the air gap length 2δ≧1 mm. The motor design and manufacture can take account of the installation tolerances and thickness tolerances of the magnets which have only a minor effect on the operating point on the demagnetization characteristic. High energy magnet manufacturing dimensions, with respect to the surface quality and the magnet thickness, are thus possible which, in contrast to ceramic magnets, do not require the surfaces to be ground. Since the largest surfaces of the magnets are covered by the pole elements and are possibly sealed with an adhesive, the corrosion protection by the magnet manufacturer may possibly not be so complex, either.

A further optimization direction for the motor dimensions is provided by the fact that only demagnetizing opposing fluxes occur which are caused by the brush yoke rotation. Since these values are small, it is possible to use magnetic materials with high remanence but with a low coercivity field strength. Even high inrush currents do not result in demagnetization of the magnets.

One major advantage of pole gap magnets is that the air gap flux is not governed solely by the magnet area above the rotor and, instead, flux concentration is possible by lengthening the magnets axially or radially.

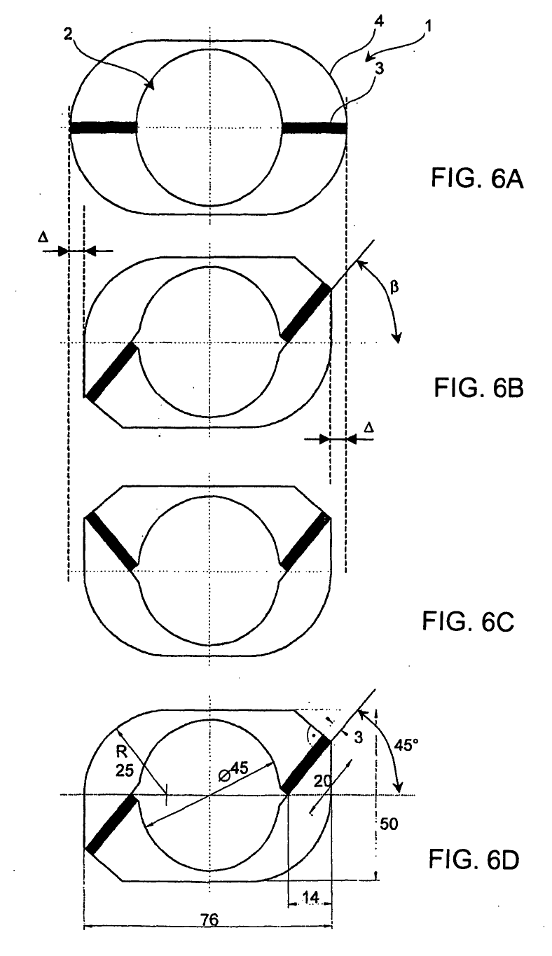

Particularly in the case of magnets whose length corresponds approximately to the rotor radius, the motor width can be reduced by also arranging the magnets at an acute angle β with respect to the air gap rather than at right angles, as is shown in the series of illustrations in FIGS. 6A to 6C. The magnets may be rotated the same way or in opposite directions in the two pole gaps, that is to say in mirror-image or point symmetrical form. This results in a number of options for physical integration of the motor in an appliance. Overall, this therefore results in a motor with the specific dimensions of the stator 4 based on the details shown in FIG. 6D. The external size has been reduced by an amount 2A to only 76 mm, in comparison to an electromagnetically equivalent version with 85 mm as shown in FIG. 6A, by positioning the magnets 3 obliquely through an angle β=45°, with the magnet dimensions remaining the same. The illustrated stator 4 is in one embodiment composed of at least two ferromagnetic moldings, which are connected to one another by adhesive bonding and/or sheathing with a housing by means of at least two high energy magnets 3 in order to form a stator which is very compact overall, and which can be manufactured easily.

The section views in FIGS. 6A to 6D once again illustrate the advantages of the chosen embodiment of a motor 1 according to the invention. This results in a more powerful and very compact motor, whose external dimensions can be matched to an overall design or to other conditions and restrictions in an available space within an appliance.

The positioning of rare earth magnets on both sides in order to form the air gap field in a symmetrical stator arrangement is associated with advantages which are summarized as follows:
Rendering the configuration symmetrical in the stator area means that the radial tension in one direction on the armature in asymmetric stators is cancelled out. This results in an improvement in the conditions for the bearings for the armature, and in a reduction in the amount of noise that is developed during operation.
The configuration of two magnets for pole gap excitation shortens the excitation lines over flux, and this leads to a reduction in the magnetic potential drop.
A reduction in the dimensions of an electric motor according to the invention can be achieved selectively on the pole gap axis or on the axial length.
Owing to the small magnet thickness of the high energy magnets, the pole arc is enlarged, so that it virtually matches the entire pole pitch.
Pole sensing torques are reduced, because the holding torques can be reduced more effectively than in the case of the prior art by smaller slot inclinations.
The rhomboid external shape of high energy magnets represents a considerably simpler magnet shape than that of pole segments composed of ceramic magnets.
Brush yoke rotation, which is carried out in order to improve the commutation, can be reduced considerably owing to the smaller pole gap.
According to the invention, it is possible to make stator yokes of any desired length, while increasing the flux concentration in the pole arc.
Lengthening of the magnets in the radial and/or axial directions allows the flux to be increased or concentrated virtually as required.
Finally, the design of flat motors in the case of these motors is not dependent on reducing the pole arc, as in the case of present-day embodiments.

1. An electric motor assembly, comprising:
an electric motor with permanent magnet excitation, said motor having a substantially symmetrical stator with pole gap excitation, and a high-energy magnet formed with a small magnet height.

2. The electric motor according to claim 1, wherein said high-energy magnet is a rare earth magnet.

3. The electric motor according to claim 1, wherein said high-energy magnet is a neodymium/iron/boron magnet.

4. The electric motor according to claim 1, wherein said high-energy magnet is a rhomboid magnet.

5. The electric motor according to claim 1, wherein said high-energy magnet is a cuboid magnet.

6. The electric motor according to claim 1, wherein said high energy magnet has a magnet height of about 1 mm to about 4.5 mm.

7. The electric motor according to claim 1, wherein said high energy magnet is a very thin magnet in comparison with a conventional ceramic magnet in a comparable machine.

8. The electric motor according to claim 1, wherein said stator has an axial stator yoke length corresponding substantially to an axial length of said permanent magnet.

9. The electric motor according to claim 1, wherein an overhang factor defined by a ratio of a core length of said rotor to an axial length of said permanent magnet is relatively small in comparison with a motor having a pole magnet with a relatively large ratio of the magnet length to a laminated core length of said rotor.

10. The electric motor according to claim 1, wherein said motor is formed with an air gap and said high energy magnet is disposed at an angle other than a right angle with respect to said air gap.

11. The electric motor according to claim 1, wherein a laminated core length of an armature of said motor is substantially equal to an axial length of said high energy magnet.

12. The electric motor according to claim 11, wherein a quotient of a value of said laminated core length of said armature and a value of an axial length of said high energy magnet lies in a range from about 0.5 to about 1.

13. The electric motor according to claim 1, wherein said electric motor is a two-pole machine.

14. A method for producing an electric motor, comprising:
providing a stator yoke and a laminated rotor core having a substantially equal length;
using a progressive die (multistage operation die, follow-on tool), and stamp-packetizing a stator and an armature to form a substantially symmetric motor with permanent magnet excitation with high-energy magnets.

15. The method according to claim 14, which comprising forming the electric motor according to claim 1.

16. The method according to claim 14, which comprises forming the stator from at least two ferromagnetic moldings and connecting the moldings with at least two high-energy magnets.

17. The method according to claim 16, which comprises forming a compact stator by at least one of adhesively bonding the at least two high-energy magnets to the ferromagnetic moldings and sheathing the assembly with a housing.
